(19) United States
(12) Patent Application Publication
(10) Pub. No.: US 2016/0309679 A1
(43) Pub. Date: Oct. 27, 2016

(54) MILKING PLATFORM

(71) Applicant: WAIKATO MILKING SYSTEMS LP, HAMILTON (NZ)

(72) Inventor: MICHAEL DAVID BATES, AUCKLAND (NZ)

(21) Appl. No.: 14/694,902

(22) Filed: Apr. 23, 2015

(51) Int. Cl. A01K 1/12

(52) U.S. Cl. CPC A01K 1/126

(57) ABSTRACT

A rotary milking platform has:
a) a deck 1 suitable for supporting cows for milking;
b) an beam 2 arranged to support the deck 1; and
c) a plurality of rollers 4 arranged to take at least a substantial amount of the weight of the beam 2 as it moves in a generally rotary fashion;
   characterised in that each roller 4 is adapted to automatically orient itself to distribute the weight of the beam 2 generally evenly over the roller 4 to avoid or substantially reduce point loading between the beam 2 and the roller 4 in the event that a least part of the beam 2 is not level.

### FIELD OF INVENTION

A preferred form of this invention relates to a rotary milking platform suitable for use with dairy cows. The platform may however have other applications, and so its preferred forms or uses should not be seen as limiting of the invention.

### BACKGROUND

Rotary dairy milking platforms are well known. They typically involve a large disc-like deck which rotates to move cows through a milking procedure. The deck is supported on a circular beam which is in turn supported on a series of rollers. When in use the beam rotates over the rollers and this can lead to it becoming undesirably worn. The wear may be quite severe if the beam gets out of level because in that case there is often substantial point loading between the beam and the rollers. It is accordingly an object of a preferred form of the invention to go at least some way towards addressing this problem.

### SUMMARY OF THE INVENTION

According to one aspect of the invention there is provided a rotary milking platform having:
a) a deck suitable for supporting cows for milking;
b) a beam arranged to support the deck; and
c) a plurality of rollers arranged to take at least a substantial amount of the weight of the beam as the beam moves in a generally rotary fashion;
   characterised in that each roller is adapted to automatically orient itself to distribute the weight of the beam generally evenly over the roller to avoid or substantially reduce point loading between the beam and the roller in the event that a least part of the beam is not level.

Optionally each roller is arranged to enable it to tilt from side to side to reduce or avoid point loading between the beam and the rollers.

Optionally each roller is arranged to tilt in response to contact from an uneven part of the beam so as to maintain substantially even contact between the roller and the beam if at least part of the beam is uneven.

Optionally each roller is mounted in a cradle which can tilt, to in turn cause the roller to tilt.

Optionally each cradle is generally U shaped.

Optionally each cradle is mounted on a load bearing pedestal.

Optionally each cradle has a pivot axis which is at right angles to the axis of rotation of its roller.

According to a further aspect of the invention there is provided a rotary milking platform having:
a) a deck suitable for supporting cows for milking;
b) a beam arranged to support the deck; and
c) a plurality of rollers arranged to take at least a substantial amount of the weight of the beam as the beam moves in a generally rotary fashion;
   characterised in that each roller has an axis of rotation and is mounted in a cradle on a load bearing pedestal,

each cradle having a pivot axis which is at right angles to the axis of rotation of its roller, and

each roller being adapted to tilt with its associated cradle from side to side to distribute the weight of the beam at least generally evenly over the roller to avoid point loading between the beam and the roller in the event that a least part of the beam is not level.

### BRIEF DESCRIPTION OF THE IMAGES

Some preferred embodiments of the invention will now be described by way of example and with reference to the accompanying images, of which:

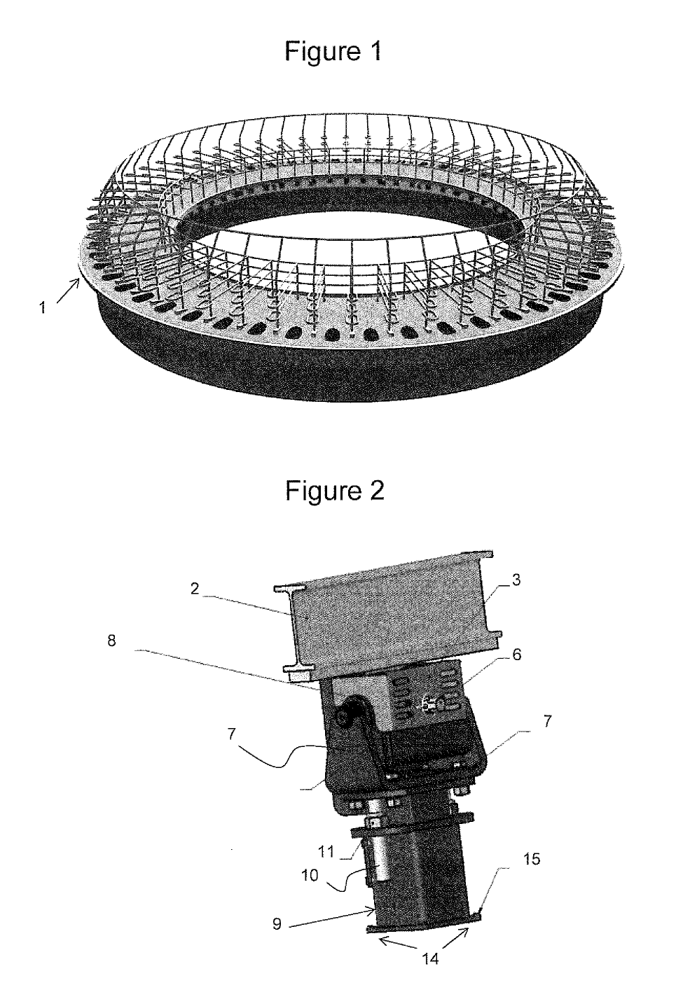

FIG. 1 is an isometric view of a rotary milking platform;

FIG. 2 is an isometric view of part of the substructure of the platform;

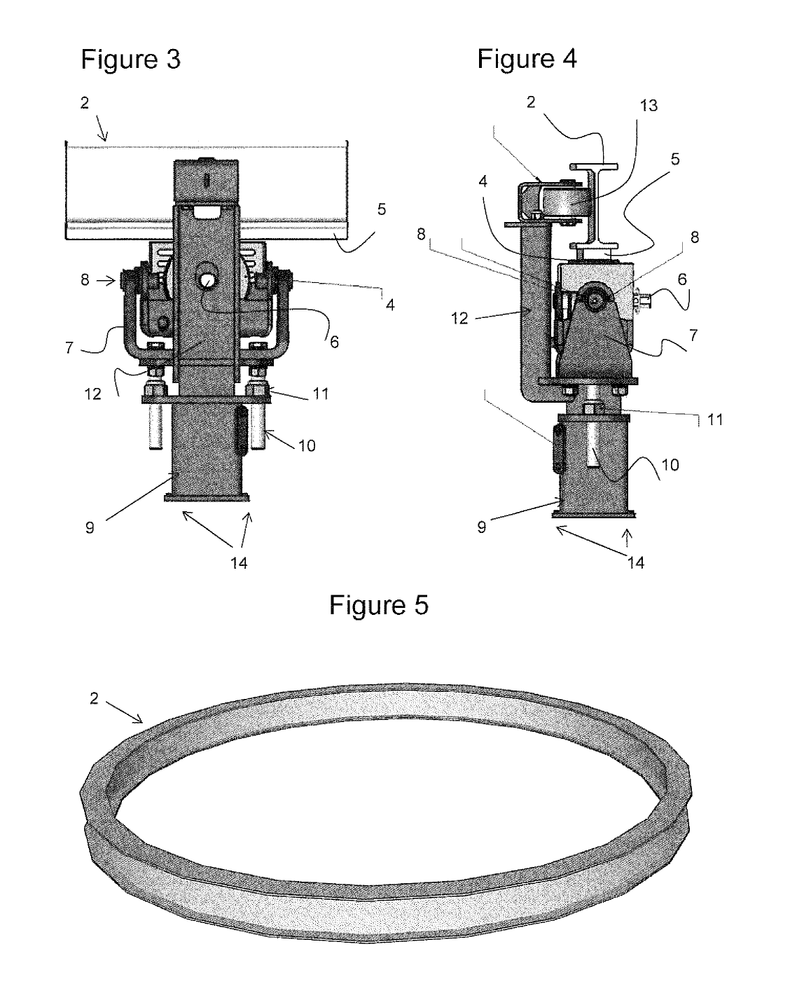

FIG. 3 is a side view of part of the substructure;

FIG. 4 is an end view of part of the substructure;

FIG. 5 illustrates a beam of the platform;

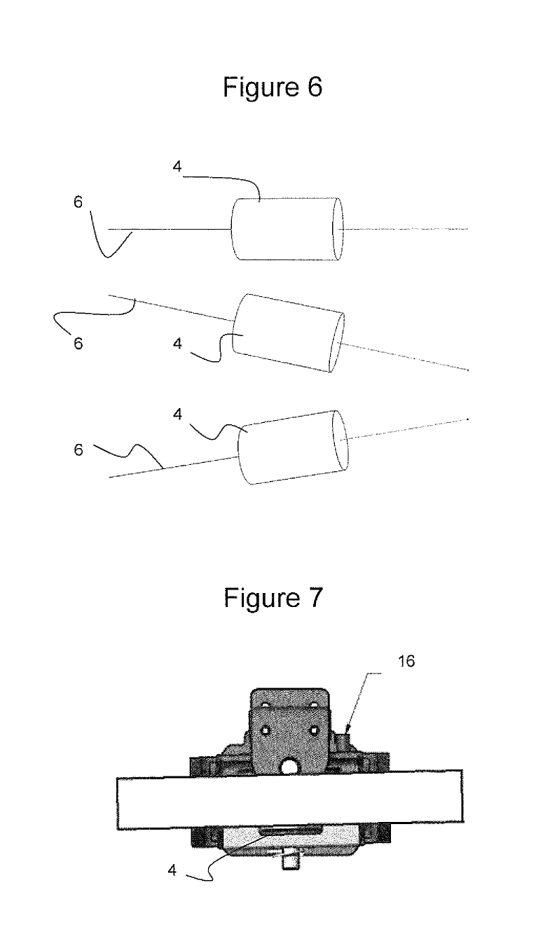

FIG. 6 illustrates the pivoting motion of a roller of the platform; and

FIG. 7 is a plan view of part of the substructure.

### DETAILED DESCRIPTION

Referring to FIG. 1, the milking platform has a deck 1 on which cows can stand while being milked. The deck 1 is supported on a load bearing I beam joined at each end to form a circle. A small part of the beam 2 is shown in in FIGS. 2-4, and it is illustrated in full at FIG. 5. It lays on a series of spaced rollers. In FIG. 2 the roller is obscured by a safety shroud 3, but it is visible in part at reference number 4 in FIGS. 3, 4 and 7. When the milking platform is in use the beam 2 rotates over the rollers to, in turn, rotate the deck to move the cows through a milking cycle.

As illustrated in FIG. 4, the beam 2 incorporates a wear resistant strip 5 which can be replaced when worn out. This helps to save the more structural parts of the beam from premature aging due to friction between it and the rollers.

Referring to FIGS. 2, 3 and 4, each roller 4 rotates about its axis 6 as the beam 2 rotates over it. If the beam 2 is or becomes out of level or otherwise uneven, then there can be significant point loading between the beam and the roller. The loading may cause the wear strip 5 of the beam and/or the roller to wear relatively fast. A prematurely worn beam or rollers can lead to expensive repairs and milking downtime. Undue downtime can be especially detrimental because dairy cows normally need to be milked regularly to reduce the risk of them developing mastitis or drying out. To address this problem the rollers 4 are arranged so that they can continuously and automatically tilt side to side if uneven parts of the beam 2 bear down on them. The tilt is such that it keeps a wide span of the roller 4 in contact with the beam 2 to avoid, or at least reduce, point loading. This is illustrated in FIG. 6, where the roller 4 is firstly shown when it is level, then when it is tilted one way, and then the other way.

The tilting ability of the roller 4 is, in the embodiment illustrated, facilitated by mounting it in a generally U shaped cradle 7, although other ways of mounting can be employed if desired. The cradle pivots on an axis 8 which is at right angles to the rotational axis 6 of the roller 4.

As also shown in FIGS. 2, 3 and 4, the cradle 7, and therefore the roller 4, is supported by a pile like pillar 9. The pillar 9 is telescopically height adjustable by way of threaded bolts 10 and nuts 11. As best seen in FIG. 4, the pillar 9 also supports a cantilevered arm 12 with a retainer roller 13 to help keep the beam 2 from moving laterally off the rollers 4 as it rotates with the deck 1.

Preferably the bottom of each pillar 9 is grub-screwed at its four corners 14 to a plate (not shown) set in a concrete foundation slab (not shown). Referring to FIG. 2, by adjusting the grub screws 15, or in some cases removing one or more of them altogether, the pillar 9 can be readily levelled.

Referring to FIG. 7, the substructure includes means to apply oil to lubricate the beam 2 as it rotates. This is facilitated by an oil reticulation tube as shown at 16.

While some preferred embodiments of the invention have been described by way of example it should be appreciated that modifications and improvements can occur without departing from the scope of the following claims.

1. A rotary milking platform having:
a) a deck suitable for supporting cows for milking;
b) a beam arranged to support the deck; and
c) a plurality of rollers arranged to take at least a substantial amount of the weight of the beam as the beam moves in a generally rotary fashion;
characterised in that each roller is adapted to automatically orient itself to distribute the weight of the beam generally evenly over the roller to avoid or substantially reduce point loading between the beam and the roller in the event that a least part of the beam is not level.

2. A rotary milking platform according to claim 1, where each roller is arranged to enable it to tilt from side to side to reduce or avoid point loading between the beam and the roller.

3. A rotary milking platform according to claim 1, where each roller is arranged to tilt in response to contact from an uneven part of the beam so as to maintain substantially even contact between the roller and the beam if at least part of the beam is uneven.

4. A rotary milking platform according to claim 1, where each roller is mounted in a cradle which can tilt, to in turn cause the roller to tilt.

5. A rotary milking platform according to claim 4, where each cradle is generally U shaped.

6. A rotary milking platform according to claim 4, where each cradle is mounted on a load bearing pedestal.

7. A rotary milking platform according to claim 4, where each cradle has a pivot axis which is at right angles to the axis of rotation of its roller.

8. A rotary milking platform having:
a) a deck suitable for supporting cows for milking;
b) a beam arranged to support the deck; and
c) a plurality of rollers arranged to take at least a substantial amount of the weight of the beam as the beam moves in a generally rotary fashion;
characterised in that each roller has an axis of rotation and is mounted in a cradle on a load bearing pedestal,
each cradle having a pivot axis which is at right angles to the axis of rotation of its roller, and
each roller being adapted to tilt with its associated cradle from side to side to distribute the weight of the beam at least generally evenly over the roller to avoid point loading between the beam and the roller in the event that a least part of the beam is not level.

9. A rotary milking platform according to claim 5, where each cradle is mounted on a load bearing pedestal.
